(19) United States
(12) Patent Application Publication
(10) Pub. No.: US 2004/0002884 A1
(43) Pub. Date: Jan. 1, 2004

(54) Method for facilitating product launches through an integrated communication process

(76) Inventor: Allan J. Lenio, Alpharetta, GA (US)

Correspondence Address: SHAW PITTMAN, IP GROUP, 1650 TYSONS BOULEVARD, SUITE 1300, MCLEAN, VA, 22102, US

(21) Appl. No.: 10/183,868

(22) Filed: Jun. 28, 2002

(51) Int. Cl. G06F 17/60

(52) U.S. Cl. 705/8

(57) ABSTRACT

A method is described for integrating corporate communications associated with product launch campaign by a corporation through a facilitator. The central facilitator identifies key stakeholders associated with a product launch, and creates a positioning statement to apply to the stakeholders to coordinate a shared message for the launch. Stakeholders are assigned action items to develop objectives, strategies and tactics for their respective functional areas. The facilitator then conducts and moderates meetings between subsets of stakeholders to eliminate redundant efforts, determine gaps in coverage, maintain consistency for the company's positioning and message, and determine cross-functional dependencies. A schedule of tasks associated for the launch is maintained by the facilitator

### BACKGROUND OF THE INVENTION

1. Field of the Invention

The present invention relates to methods for launching products or services in a multi-department corporate environment, and more particularly, to a method for facilitating an effective launch campaign by centralizing responsibilities for coordinating corporate strategies, product development, and communications.

2. Background Information

In any large corporation, the process of launching new products or services can often be a difficult and disjointed effort. Companies typically strive to develop and launch products within tight deadlines and under compressed schedules to remain competitive. As a result, there may be little time before launch to develop effective advertising campaigns, sales plans, community relations strategies, or other such initiatives that can be important for ensuring a successful launch.

To maintain an accelerated pace, corporate departments may schedule some tasks to occur simultaneously or to overlap with those being performed by other departments. If information that is necessary for some tasks will not become known until the completion of other, overlapping tasks, there may be occurrences when tasks are performed based upon incomplete information or assumptions. Such instances can negatively impact the success of a product launch if a department relies upon incorrect assumptions. This problem occurs routinely in large corporate entities where different departments or divisions are managed and operated separately with inadequate interdepartmental communications.

The difficulties that may be encountered when a product launch is to be performed in a conventional manner can be further described by an example. For the purposes of this example, consider a fictional automotive company that is completing its design and performance testing of a new type of car. A company organization chart illustrating the divisions within the company that each have responsibilities for the launch of the car is provided in FIG. 1A. As can be seen, the product development, engineering/testing, media relations, marketing/promotions, and inventory management divisions of the company are each included as having tasks to be performed prior to the launch.

FIG. 1B provides a timeline schedule for when each division should start and complete tasks associated with the launch, assuming that there are no severe time restrictions. Under this scenario, the engineering/testing division conducts a first testing phase (2) after the product development division completes a first prototype (1), and then begins a second testing phase (5) after the product development division completes refinements to the prototype (4), based upon the previous testing results. The media relations division begins notifying the press (3) about the anticipated product once the first testing phase (2) is completed, and once again (6) after the second testing phase (5) is completed, based upon performance testing results. Advertising (7) begins once the second testing phase (5) is completed, followed by a formal advertising campaign (9) after launch. Finally, inventory is to be ordered (8) shortly before launch to manufacture the car.

An advantage associated with scheduling tasks as shown in FIG. 1B is that each division can easily communicate the results of a completed task to other divisions in the company before another division begins a new task. For example, if the media relations division waits until after the engineering/testing division determines that the prototype car will have 220 hp (after completing the first testing phase (2)), as opposed to a hoped-for 260 hp, the media relations division can correctly report this to the press (3). Similarly, if the product development division waits until after the conclusion of first testing phase (2) to perform refinements (4), it can avoid re-engineering components of the car that are believed to be operating correctly.

Continuing with the example of a fictional launch of the automobile, consider a scenario in which the automotive manufacturer decides to rush the anticipated launch date, perhaps to roll out new convertible vehicles at the beginning of the summer buying season. FIG. 1C provides a possible timeline by which the tasks of FIG. 1B are performed during overlapping times in order to launch the product under an accelerated schedule. As shown in FIG. 1C, the first phase of product testing (2) occurs concurrently with the first phase of product development (1), the second phase of product development (4) is performed prior to the conclusion of first phase of product testing (2), and the media relations division begins a task (3) during the middle of the first phase of product testing (2).

Although it is possible that each of the tasks can be completed correctly under the abbreviated schedule in FIG. 1C, the overlapping performance of these tasks increases the risk of problems. For example, if the media relations group assumes and announces to the press (3) that the car will have 260 hp (based on the designs generated during the first product development phase (1)), and the car later launches with only 220 hp (as determined during first phase testing (2)), this difference may disappoint the expectations of prospective purchasers. As another example of a potentially more serious problem, if the product development group fails to correct a technical defect during the second phase of development (4) that was discovered late in the first phase of testing (2), the car may be manufactured with the technical defect. When the defect is ultimately discovered, this lapse may jeopardize the launch altogether.

In launching a product, it is particularly important that corporate communications are coordinated to ensure delivery of a consistent “message.” For example, a pre-launch advertising campaign for a car with 260 hp projects a different “image” and targets different prospective buyers than a campaign for a new 220 hp car. Accordingly, when the car is later launched with only 220 hp, the costs associated with generating pre-launch media hype for a 260 hp car were wasted.

It is particularly common for an inconsistent “message” to be delivered inadvertently by different departments within a company. Information concerning the development and launch of a new car may be relevant to numerous divisions, such as a “shareholder relations” division (e.g., to build confidence in shareholders' investment in the company), a “corporate industry relations” division (e.g., informing vendors and suppliers to anticipate orders), a “community relations” division (e.g., the launch of the product may affect power consumption and pollution), a “media relations” division (e.g., to prepare the press for the product launch), and an “advertising” division (e.g., to promote the new product), among others. Continuing with the example of the car launch for an automotive company, numerous problems can result if the “shareholder relations” division of the company tries to please investors by describing a product that will appeal to affluent middle-aged drivers, while the “media relations” division explains to the press that the company envisions that the car is to be priced for college-aged drivers.

The difficulties and inefficiencies that multi-department, large corporations face when launching a product typically occur because of the inherent difficulties in scheduling and providing effective communications between distinct departments within the corporate structure. This problem is only compounded when different departments fail to assimilate their distinct responsibilities to create and provide a consistent “message” to be communicated to shareholders, customers, and all other members of the public. Considering further that each department may have several sub-groups or divisions, each with several employees with different responsibilities for the launch, many companies may accept it as inevitable that some tasks will be mis-scheduled and that information will be mis-communicated, both internally and externally. Alternatively, others may schedule too many meetings and send too much information between departments, thereby compromising efficiency in order to improve accuracy.

In view of the foregoing, it can be appreciated that there is a substantial need for a method for effectively and efficiently planning, organizing, and scheduling product launches within multi-department corporate organizations. The method should enable departments to schedule tasks and projects based upon up-to-date information. Further, this method should assist the company's efficiency by reducing the volume of redundant, unnecessary communications. Finally, the method should enable a corporation to provide a consistent “message” to maximize the effectiveness of a product launch and associated campaign.

### SUMMARY OF THE INVENTION

The present invention relates to a method for facilitating product launches using a process for integrating corporate communications. A central facilitator coordinates communications and activities to be undertaken by different corporate divisions. Scheduling is performed dynamically during the course of the launch preparation, based upon the state of progress for ongoing tasks, changes in deadlines, and other factors.

In accordance with an embodiment of the present invention, the central facilitator identifies key stakeholders associated with a product launch, and creates a positioning statement to coordinate a shared message for the launch. Stakeholders are assigned action items to develop objectives, strategies and tactics for their respective functional areas. The facilitator then conducts and moderates meetings between subsets of stakeholders to eliminate redundant efforts, determine gaps in coverage, maintain consistency for the company's positioning and message, and determine cross-functional dependencies.

Once a budget is determined and a launch plan is approved, a fast track process is implemented for providing external communications. The facilitator moderates a series of meetings between subsets of stakeholders, wherein the timing of the meetings and the stakeholders selected to participate are determined dynamically.

Accordingly, it is an object of the present invention to provide a method for integrating corporate communications associated with product launch campaign by a corporation through a facilitator. A plurality of market segments are identified, and at least one stakeholder is identified for each identified market segment. A proposed schedule of tasks associated with a product launch campaign is received from each of the plurality of stakeholders. The proposed schedules are integrated to remove redundant tasks, and the tasks are coordinated into a sequence to be performed relative to tasks proposed by other stakeholders.

It is another object of the invention to provide a method for organizing the performance of tasks required for a corporate product launch campaign. A proposed schedule of tasks associated with a product launch campaign is received from each of a plurality of stakeholders. Each proposed task identifies what information is required to perform the task and what information is expected to be identified by performance of the task. A master schedule of tasks is created by organizing tasks to be scheduled such that each task requiring information to be identified by another task is scheduled after the other task. The amended schedule is dynamically amended in response to changes in the performance of tasks, such that a change in the scheduling of a first task causes a change in the scheduling of tasks that require information that is expected to be identified by performance of the first task.

It is yet another object of the present invention to provide a method for coordinating external communications associated with a corporate product launch campaign. A plurality of stakeholders are identified, each of whom provides external communications during a corporate product launch campaign to one or more market segments. Prospective positioning statements are received from each of the stakeholders, and internal communications are coordinated between subsets of stakeholders to eliminate redundant portions or to identify gaps in coverage in respective stakeholder positioning statements.

### BRIEF DESCRIPTION OF THE DRAWINGS

FIG. 1A is an illustration of an organizational chart of multiple departments or divisions within a company that have involvement in the launch of a product by the company, as background for describing the present invention.

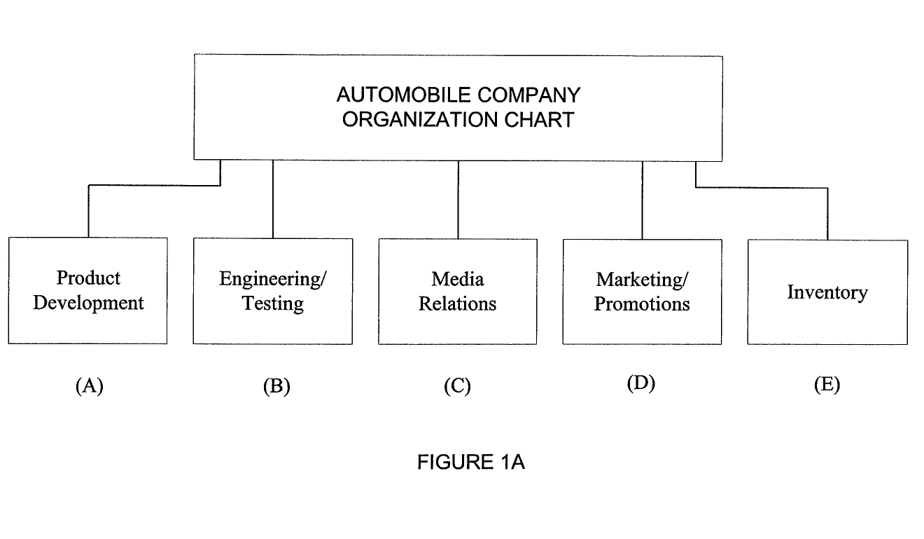

FIG. 1B is an illustration of a timeline by which activities are performed by the departments identified in FIG. 1A in connection with launching a product by a company, when the company does not encounter unexpected time restrictions.

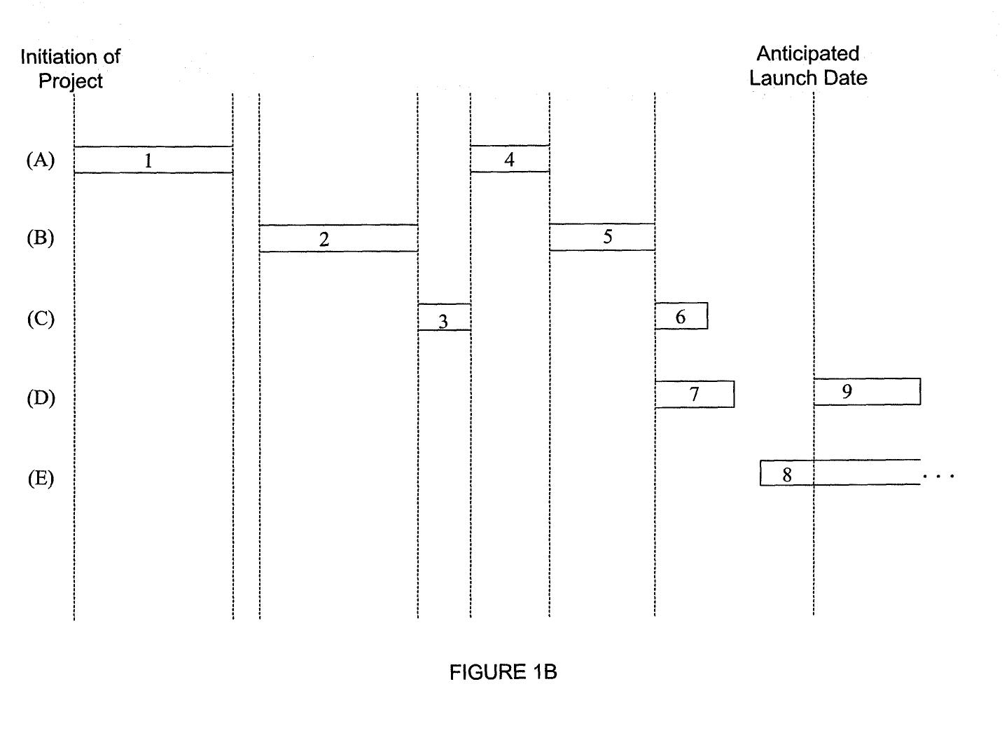

FIG. 1C is an illustration of a timeline by which the activities of FIG. 1B may be performed by the departments when the company encounters unexpected time restrictions.

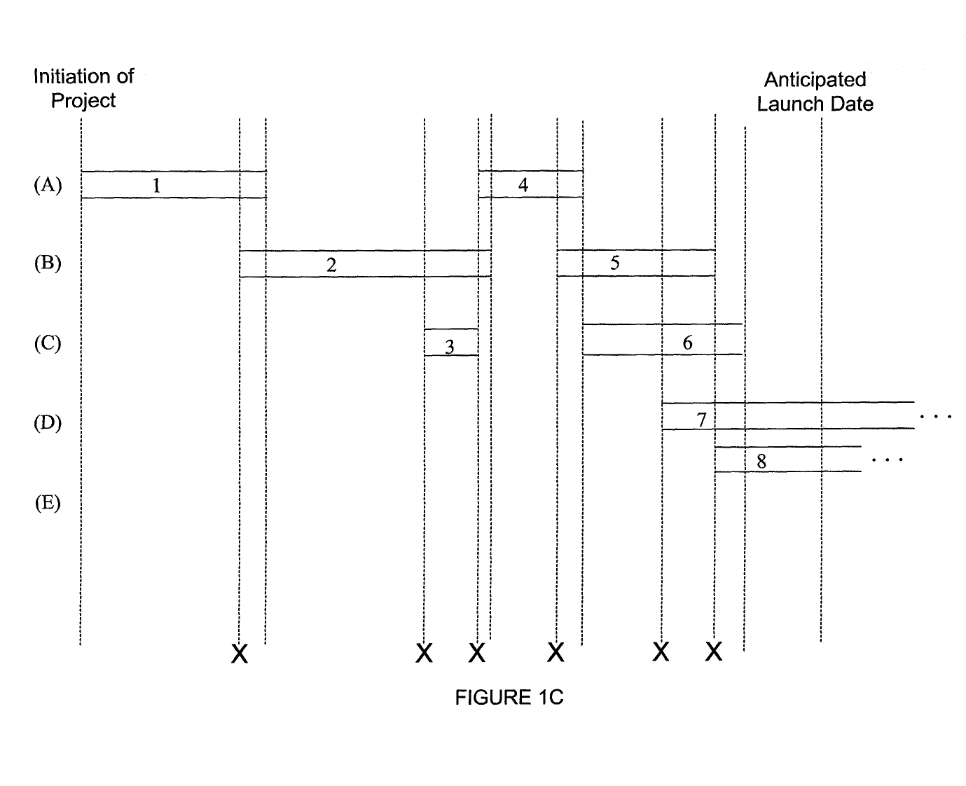

FIG. 2 is a schematic diagram representing exemplary interrelationships between various departments within an exemplary corporation according to the present invention.

FIG. 3 is a flow diagram representing an exemplary process or guideline to be followed by a facilitator in accordance with an embodiment of the present invention.

FIG. 4A illustrates an example according to an embodiment of the present invention in which a file of proposed strategies and tasks is provided by each department that is participating in a launch.

FIG. 4B illustrates an example of a portion of a file in FIG. 4A for a Channel Advertising stakeholder.

FIG. 5 is a continuation of a flow diagram from FIG. 3, representing an exemplary process that to be followed by a facilitator in accordance with an embodiment of the present invention.

FIG. 6 is a continuation of a flow diagram from FIG. 5, representing an exemplary process or guideline to be followed by a facilitator in accordance with an embodiment of the present invention.

FIG. 7 is an example of a schedule of meetings according to an embodiment of the present invention that may change dynamically based upon the continuing progress of the launch campaign.

### DETAILED DESCRIPTION OF THE INVENTION

The present invention is directed to a method for facilitating product launches using a process for integrating corporate communications. This method centralizes responsibility for launching products by a multi-department company through a “facilitator.” A facilitator can be an individual who is associated with or employed by the company, either in one of the corporate departments that is directly involved in launching the product, or otherwise in a separate department specializing in coordinating product/service launches for the company. The facilitator may instead be employed by a third-party organization that specializes in coordinating product/service launches for clients. Alternatively, a facilitator may be an automated software product or system that dynamically organizes and integrates information and data that is to be selectively shared among various sub-groups within a company at different times throughout a campaign for launching a product, or arranges dynamically changing schedules amongst the sub-groups.

The method to be described is particularly applicable to campaigns for a product/service launch by a corporate conglomerate. A large corporation may have thousands of employees working in many divisions, in which each division includes multiple departments and sub-groups within the departments, and many layers of management. Alternatively, the method of the present invention can also be applied for use in product launch campaigns by any entity where different individuals are responsible for different aspects of the launch.

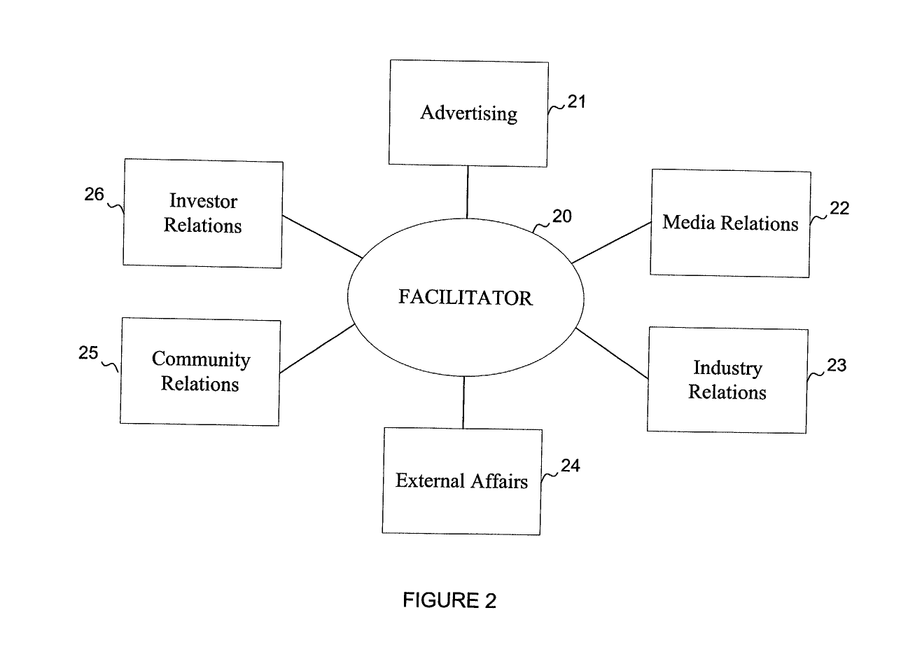

FIG. 2 is a schematic diagram representing exemplary interrelationships between various departments within an exemplary corporation. Each department is affiliated with launching a particular product or service. As shown in the FIG. 2, in this example the departments responsible for Advertising (21), Media Relations (22), Industry Relations (23), External Affairs (24), Community Relations (25), and Investor Relations (26) are each linked to communicate with a central “facilitator” (20) that coordinates the collective efforts of multiple departments. In other words, while each department is primarily responsible for its respective specialty, departments relinquish responsibility to the facilitator for inter-department communications and certain launch-specific issues. The five departments listed in FIG. 2 are intended only as an example, and the actual departments corresponding with a facilitator will vary depending upon the specific nature and organization of the company launching the product, in addition to the type of product being developed and launched.

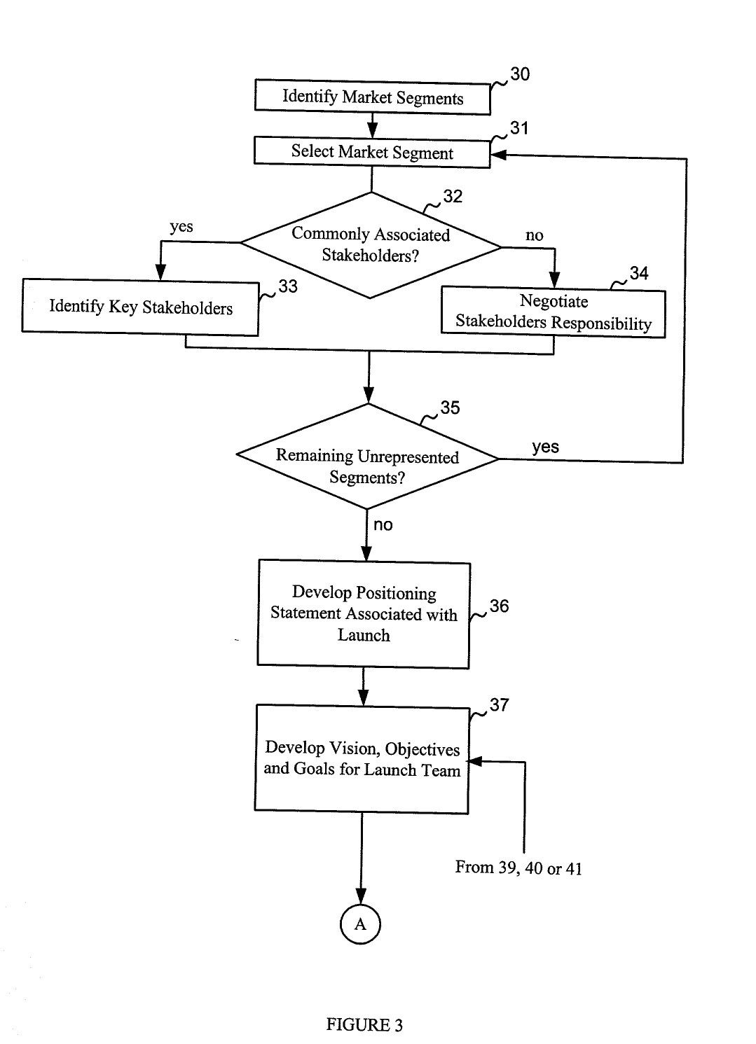

FIGS. 3, 5 and 6 are flow diagrams representing an exemplary process or guideline to be followed by a facilitator in accordance with an embodiment of the present invention. Since the organizational structure of corporations and every product launch are unique, it is possible that some of the described steps can be eliminated or approached in a different order. Additionally, some of the steps, or even sections of the diagram, may not be necessary if the launch is for a new version or release of an existing product or service.

As shown in FIG. 3, a first action that may be taken by a facilitator in accordance with the present invention is to identify Market Segments in step 30 for the product/service and the corresponding departments that support that market segment. The market segments are those individuals or groups to whom the “message” is to be targeted. In other words, “market segments” include categories of groups or individuals whom the company should contact and communicate during the launch campaign. Market segments may include prospective customers for the product/service to be launched, perhaps distinguished by demographics, but may also include others who will be affected by or will otherwise respond to the launch. Market segments may also include individuals who will affect the purchasing decisions of prospective customers.

As examples of “market segments,” it may helpful to lobby certain government agencies (e.g., for the launch of an ultra-low emissions car) or to form partnerships or alliances with other businesses (e.g., for the launch of a new computer operating system that requires support from third party software to be useful) to ensure success for the product launch. Market segments may be personally identified by the facilitator. In an alternative embodiment, corporate executives identify target segments into a software program, perhaps from a listing maintained in a database.

Once the market segments are identified (or concurrently as they are identified), each market segment is selected in step 31. In step 32, it is determined whether there is at least one stakeholder that is commonly associated with the selected market segment. A stakeholder is department or division or group within a company, or more typically an executive, manager or representative of the department, division, or group, who is committed to interacting with the facilitator to identify and perform tasks in connection with the launch. Typically, although not necessarily, at least one stakeholder is involved in the technical development of the product or service product development for the product, and a plurality of stakeholders are involved with corporate communications, media, advertising, sales, etc.

For example, if it will be necessary to interact with a government agency (e.g., the Federal Communications Commission (FCC)) during the launch, it follows that a manager in the Government Relations department of the company will be a stakeholder. If the Media Relations department has connections with media affiliated with that same government agency (e.g., trade journals), an individual in that division may also be identified as a stakeholder. Stakeholders may be personally identified by the facilitator, who is thereby crafting a team of departments within the company that will be affiliated with the launch. Alternatively, stakeholders may be automatically identified through a database that associates divisions, departments, or individuals within the company with identified market segments. One stakeholder may be responsible for multiple Market Segments and more that one stakeholder may be identified with any given Market Segment.

Depending upon the organization of the company, it is possible that at least one stakeholder cannot be identified in step 33. In that case, the facilitator negotiates responsibility between one or more candidates to become a stakeholder in step 34. As an example, if a small business that is launching a telecommunications product does not have a Government Relations department, the facilitator may utilize his personal knowledge of the company to determine which department should expand its capabilities to include this responsibility. In an automated system of the alternative embodiment, such decisions may be made through an automatic generation of emails to request proposals or recommendations for a department or an individual within a department to assume this responsibility. Since the individual, or the respective department, does not typically assume this responsibility, the assignment may affect salaries and budgeting, to be addressed when budgeting for the launch. In step 35, once it is determined that all of the target segments are represented by at least one respective stakeholder, an integrated launch team can be been identified.

In step 36, the facilitator develops a Positioning Statement associated with the launch. A positioning statement is a central “message” or theme that applies to the company, the product or service being launched, and the strategy or approach that the company is taking to launch the product. The positioning statement should be sufficiently broad to be applicable to all of the stakeholders who are involved in corporate communications, and should become a guideline by which activities relating to sales, marketing, lobbying, etc. are measured to ensure that the company's external communications are consistent. Although FIG. 3 shows step 36 as occurring after all stakeholders are identified, the Positioning Statement may be developed at any time before stakeholders develop respective objectives, goals, strategies, and prospective tasks in step 37. If stakeholder have already been identified, however, they may meet with the facilitator to coordinate the development of the positioning statement.

As an example of a positioning statement, consider a hypothetical in which a pharmaceutical company that is well-known for headache pain-reliever medications is launching an arthritis medication. The Positioning Statement may include concepts such as trust, effectiveness, brand loyalty, leadership in medical research, etc.: “Now, from the company that you've trusted for 50 years and who has been proven leader in the most advanced research for pain relief, another effective remedy has been found for commonly-associated pain . . . .”

After the positioning statement is developed, the facilitator assigns each stakeholder to develop Objectives, Strategies and Tactics (“OSTs”) in step 37. OSTs include a strategy to be taken by the stakeholder that is intended to be consistent with positioning statement associated with the launch. Returning to the example of the pharmaceutical company, the media relations stakeholder may issue a press release five months prior to launch, with a “message” that “the proven leader in the most advanced research for pain relief is bringing you another product you can trust . . . .” Since this is consistent with the positioning statement, it will be consistent with corporate communications from other departments who adhere to the positioning statement. As another example, a proposed press release that provides a “message” that “we are reinventing ourselves to now focus on the arthritis suffering market” would be inconsistent with the positioning statement, and therefore would be detrimental maintaining consistent communications concerning the launch.

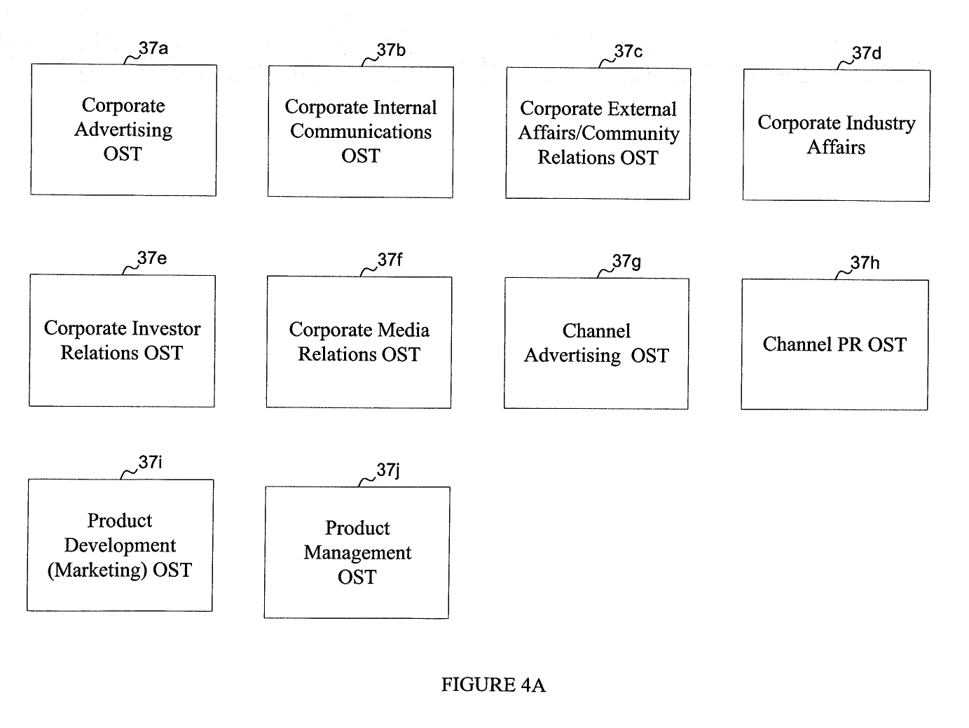

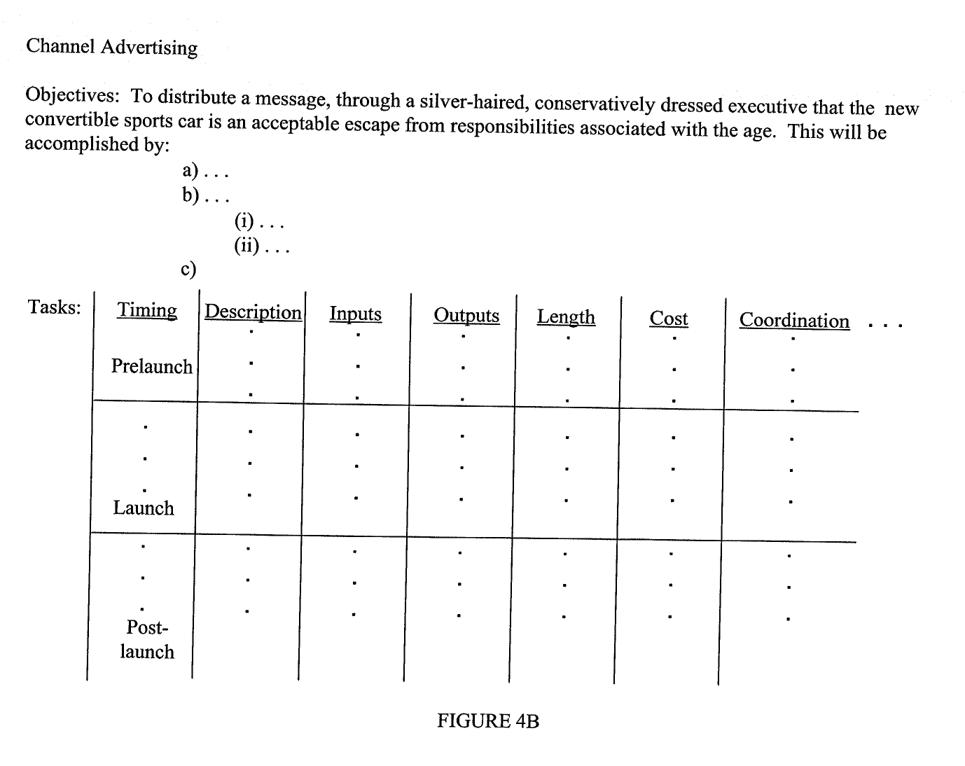

Preferably, OSTs are specific for each department, according to their respective functional areas. OSTs also include tasks anticipated to be performed, relative timing considerations, and necessary inputs and variables associated with each task. OSTs are preferably organized in time sequences or stages (e.g., pre-launch, launch and post-launch) to be identified by the facilitator, to enable grouping for coordinated time scheduling across all stakeholder tasks. OSTs can also include budget information for allocating funds associated with the launch among the stakeholders. OSTs also identify “hand-offs” between stakeholders, which occurs whenever one stakeholder should be responsible for a portion of a task that is to be completed by another. Although not required, OSTs can then organized as files to be filed in a central repository maintained by the facilitator for tracking. FIG. 4A illustrates an example in which an OST file is provided by each department that is participating in the launch. FIG. 4B illustrates an example of a portion of an OST for the Channel Advertising stakeholder. This information is to be presented in 37g of FIG. 4A. The table shown in FIG. 4B can be presented in a spreadsheet or other database schema that enables the facilitator to import and export information for coordinating schedules and generating reports.

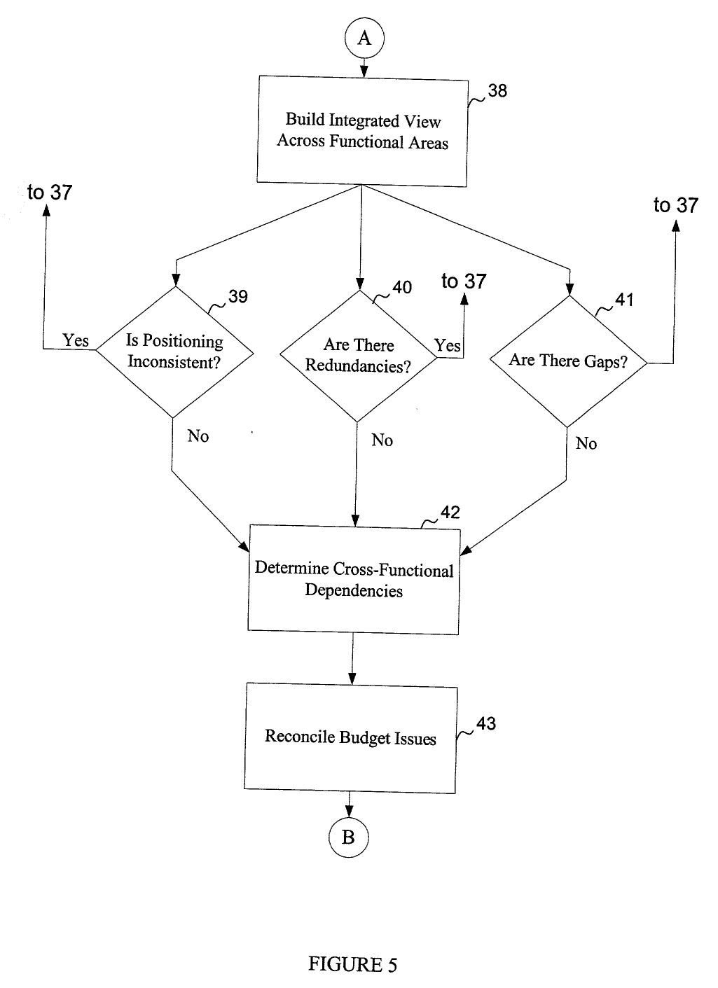

Using the OSTs that were generated, an Integrated View Across Functional Areas can be created, in step 38 (see FIG. 5). This can be done by holding a series of stakeholder meetings, in which the facilitator moderates discussions among subsets of stakeholders to promote a consistent “message” for the launch. In an automated fashion, conflicts between proposed timelines for proposed tasks can be detected. As part of the process for building an Integrated View, in step 39 the facilitator determines whether the “message” associated with the tasks proposed by each stakeholder are consistent with the positioning statement (i.e., is the same “message” being delivered), in step 40 whether there are any redundancies between the stakeholders (e.g., two stakeholders had intended to perform the same task), and in step 41 whether there are any gaps (e.g., two stakeholders each intended for the other to be performing the task). If it becomes clear that there are inconsistencies, redundancies or gaps that are found, then edits are made to the OST, back in step 37.

Once the Integrated View is created, in step 42 the facilitator determines the cross-functional dependencies. Cross-functional dependencies may include data that is to be shared among stakeholders to complete tasks, and may identify tasks that are to be performed simultaneously or with cooperation from one or more stakeholders. Perhaps most significantly, the process of determining cross-functional dependencies includes creating a schedule of meetings or a flow of communications or data between stakeholders during the pendency of the launch campaign.

A determination of how the budget is to be allocated among the stakeholders is considered next in step 43. Since the facilitator is a central figure responsible for launch-related issues, strategically he is the best able to allocate funding for the launch campaign. Each stakeholder has a competing interest for funding, which can be reconciled by an objective facilitator, whose sole interest is to maximize the success of the launch as a whole, as opposed to particular components of the launch.

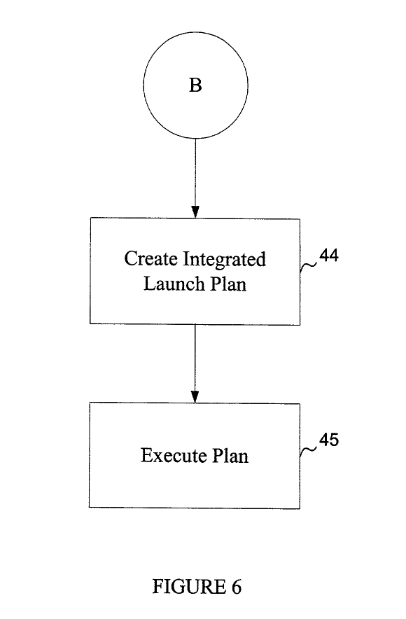

As shown in FIG. 6, the facilitator creates an integrated launch plan in step 44 for distribution to corporate executives for approval. Separate and distinct from a product concept plan, a technical product development plan, a budget or a marketing plan, an “integrated launch plan” draws from the positioning statements, OSTs, tasks to be performed by each stakeholder, and the budget for the launch to enable an executive to review a complete guide to the launch in a single source. By following the integrated launch plan, the facilitator can maximize the likelihood that the goals between various divisions of the company remain consistent, that tasks are scheduled and performed in a timely manner, and that results from the tasks are communicated to those who need them.

As it is unlikely that the launch campaign will be executed exactly as it was prepared, another key advantage of developing the integrated launch plan is that it enables stakeholders to quickly and effectively re-organize in response to changes. For example, if the product testing division identifies a defect that will delay the launch by a few weeks, this can change many aspects of the launch campaign. Continuing with this example, if the advertising department was scheduled to work overtime to complete its tasks by the earlier deadline, the facilitator may now be able to revise this schedule to accommodate a few more weeks, saving overtime costs. This adds capital to the budget, which can be reallocated to another stakeholder. If the facilitator is kept informed about the status of the delay from the product testing division, he can in turn coordinate with all of the other stakeholders to maximize the benefit or minimize the detriment associated with the change.

Once the plan is approved, the facilitator then executes the plan in step 45. At this stage, the facilitator actively tracks the progress of tasks and activities conducted by the stakeholders and acts as a conduit to provide relevant information between the stakeholders. Particularly, the facilitator coordinates meetings between subsets of stakeholders who are needed to either provide or receive particular information, to minimize the number of unnecessary meetings between stakeholders.

As the launch date approaches, it is likely that the facilitator will coordinate inter-department communications and planning relating to advertising, external communications, operational strategies, media relations. Since the facilitator is a central figure in the launch, it is his responsibility to determine when to begin a fast-track advertising campaign, to coordinate all reporting requirements, to schedule any necessary training associated with the launch, to coordinate the release of competitively-sensitive information, and the like. The facilitator is therefore in constant communication with different subsets of stakeholders to coordinate the performance of these, and other such tasks.

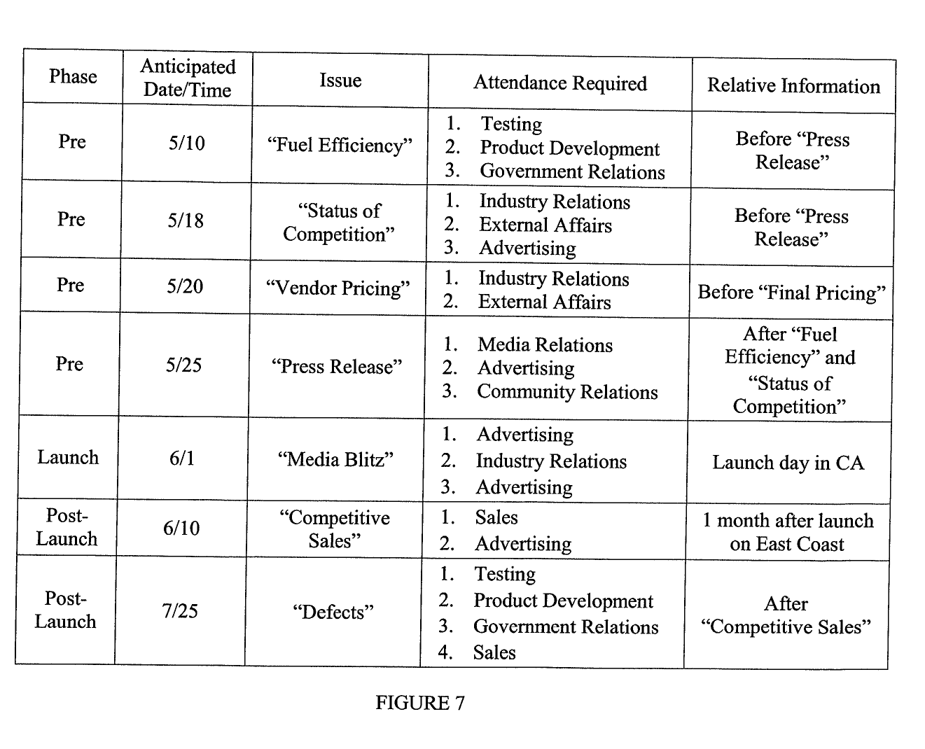

FIG. 7 provides an example of how meetings with stakeholders may be coordinated during the launch campaign. In this example, anticipated tasks are scheduled to occur at one of three stages: (i) pre-launch, (ii) launch, and (iii) post-launch, and the OSTs submitted by stakeholders indicate what inputs are necessary for performing tasks and the type of outputs/results that are expected to be generated. Based upon this information, a facilitator can determine, for particular issues and planning of tasks, which different subsets of stakeholders are to meet together, and when.

The chart in FIG. 7 is a schedule of meetings that may change dynamically based upon the continuing progress of the launch campaign. Specifically, based upon the “phase” and “relative information” fields in the chart, the facilitator can re-schedule meetings if the status of campaign changes by re-scheduling to meeting to still occur during the same “phase” and before or after another meeting as specified in the chart. For example, if a testing procedure for determining fuel efficiency was delayed from May 10 until May 27, the facilitator can determine that the meeting for determining the contents of the press release should be delayed until the reporting of the fuel efficiency.

As can be seen, the method of the present invention centralizes responsibility for launch-related tasks to a central facilitator. The facilitator acts as a conduit for information to be shared between a plurality of stakeholders who are involved in the launch. By maintaining this information, the facilitator can develop budgets, plan meetings, and reschedule tasks and meetings dynamically based upon unexpected changes to the timing of the launch campaign.

The foregoing disclosure of embodiments of the present invention has been presented for purposes of illustration and description. It is not intended to be exhaustive or to limit the invention to the precise forms disclosed. Many variations and modifications of the embodiments described herein will be obvious to one of ordinary skill in the art in light of the above disclosure. The scope of the invention is to be defined only by the claims appended hereto, and by their equivalents.

What is claimed is:

1. A method for integrating corporate communications associated with a product or services launch campaign through a facilitator, comprising the steps of:
identifying a plurality of market segments;
identifying at least one stakeholder for each identified market segment;
receiving from each of the plurality of stakeholders a proposed schedule of tasks associated with the product or services launch campaign;
integrating the proposed schedules to identify and remove redundant tasks, gaps, and inconsistencies; and
coordinating a sequence of tasks to be performed by each of the plurality of stakeholders relative to tasks proposed by other stakeholders.

2. The method of claim 1, wherein at least one demographics group of prospective customers is identified as a market segment.

3. The method of claim 1, wherein the plurality of market segments identifies individuals or organizations whom the company anticipates might become knowledgeable of, affected by, or affiliated with the launch.

4. The method of claim 1, wherein the step of identifying stakeholders is performed by searching a database of market segments, wherein the database includes a list of market segments associated with each stakeholder.

5. The method of claim 4, wherein a stakeholder is assigned to a market segment when the target segments database does not identify a stakeholder, and wherein the assigned stakeholder is most closely affiliated with the target segment from among a group of stakeholders in the company.

6. The method of claim 1, wherein the proposed schedule of tasks includes an identification of the anticipated inputs required and results to be generated by performance of the task.

7. The method of claim 6, wherein a task is scheduled by determining when all required inputs will become available, based upon the results to be generated by performance of other tasks.

8. The method of claim 1, wherein the proposed schedule of tasks includes an identification of a stage in the product launch campaign during which the task is required to be performed.

9. A method for organizing performance of tasks required for a campaign to launch a product or service comprising the steps of:
receiving a proposed schedule of tasks associated with the product or services launch campaign from each of a plurality of stakeholders, wherein each proposed task identifies what information is required to perform the task and what information is expected to be identified by performance of the task;
creating a master schedule of tasks by organizing tasks to be scheduled such that each task requiring information to be identified by another task is scheduled after the other task; and
dynamically amending the master schedule in response to changes in the performance of tasks, wherein a change in the scheduling of a first task causes a change in the scheduling of tasks that require information that is expected to be identified by performance of the first task.

10. The method of claim 9, further comprising the step of dynamically amending budget allocations for performances of tasks by stakeholders in response to changes in the master schedule.

11. A method for coordinating external communications associated with a product or services launch campaign, comprising the steps of:
identifying a plurality of stakeholders, wherein each stakeholder provides external communications during a corporate product launch campaign to one or more market segments;
creating a positioning statement associated with the product launch campaign; and
coordinating external communications to be provided by stakeholders during the launch campaign to ensure that communications are consistent with the positioning statement.

12. The method of claim 11, wherein the stakeholders include at least a representative for respective departments responsible for media relations and advertising.

13. The method of claim 11, further comprising the steps of:
receiving a prospective schedule of tasks from each stakeholder to be performed by the respective stakeholder;
identifying whether any prospective tasks are redundant or inconsistent with prospective tasks to be performed by other stakeholders; and
coordinating a sequence of tasks to be performed by each of the plurality of stakeholders relative to tasks proposed by other stakeholders.

14. The method of claim 11, further comprising the step of identifying cross-functional dependencies between the prospective tasks to be performed by the stakeholders.

15. The method of claim 11, further comprising the step of identifying deviations in stakeholder performance of tasks as compared to the sequence, and revising scheduling of tasks accordingly.

16. A method for scheduling a series of tasks to be performed in a campaign to launch a product or service, comprising the steps of:
identifying a plurality of prospective tasks that are to be performed by a plurality of stakeholders, wherein each prospective task is associated with a launch stage and priority criteria;
segregating each of the prospective tasks according to the respective identified launch stage; and
within each launch stage, determining a sequence by which each of the prospective tasks are to be performed according to the priority criteria,
wherein, for any two tasks having the same priority criteria, coordinating communications among persons responsible for performance of the tasks to facilitate a sharing of necessary information concurrent with the performance of the tasks.

17. The method of claim 16, wherein the launch stage is identified as one of pre-launch, launch, or post-launch.

18. The method of claim 16, wherein the priority criteria includes a description of any information that is necessary for performance of the task, and any information to be determined by performance of the task.
